(19) United States
(12) Patent Application Publication
(10) Pub. No.: US 2025/0091157 A1
(43) Pub. Date: Mar. 20, 2025

(54) APPARATUS FOR PROCESSING AN OBJECT BY LASER

(71) Applicant: OROTIG S.P.A., Castelnuovo del Garda (IT)

(72) Inventors: Martino FASOLI, Castelnuovo del Garda (IT); Tommaso ROMANELLI, Castelnuovo del Garda (IT); Raffaello COSENTINO, Castelnuovo del Garda (IT)

(21) Appl. No.: 18/728,114

(22) PCT Filed: Jan. 2, 2023
(86) PCT No.: PCT/IB2023/050011

§ 371 Date: Jul. 11, 2024

(30) Foreign Application Priority Data
Jan. 13, 2022 (IT) 102022000000482

(51) Int. Cl. B23K 26/08; B23K 26/70

(52) U.S. Cl. CPC B23K 26/08; B23K 26/706

(57) ABSTRACT

An apparatus is described for processing an object by laser, comprising
a support base comprising a treatment area for the object,
a laser,
a stand mounted on the base to keep the laser at a distance from the base and pointed at the treatment area, and
a casing or cover to enclose the stand and the laser.

To reduce the size, there are
means for lifting the casing or cover from the base to a raised position where access to the treatment area is permitted, and
means for rotateing the casing or cover around a—in use—horizontal axis while the casing or cover is in the raised position.

### TECHNICAL FIELD

The present invention relates to an apparatus for laser processing of an object, such as a laser welding or marking apparatus, particularly for welding or processing jewelry and precious objects in general, or also in industrial and medical fields.

### BACKGROUND

Known laser marking apparatus, taken here as an example, includes a base, on which objects to be processed can be placed, and a laser mounted on the base. A front screen (casing) encloses the base for safety and is provided with a transparent window for looking at the object to be processed. The casing is translatable vertically with respect to the base so that it can enclose the apparatus or can be lifted up leaving free access to the working area on the base under the laser.

The volume of the fully vertically raised front casing generally adds up to that of the apparatus, making the assembly quite bulky in height.

### SUMMARY

The main object of the present invention is to provide an apparatus of the above type that is less cumbersome when opened.

Another object is to provide an apparatus of the above type that is inexpensive and simple to make.

Another object is to provide an apparatus of the above type that is safe for the operator during operations.

These and still other objects, which will better appear later, are achieved by an apparatus defined as in the attached claims, where the dependent ones define beneficial variants.

The apparatus for processing an object by laser, comprises:
a support base including a treatment area for the object,
a laser,
a base-mounted stand to keep the laser at some distance from the base and pointed toward the treatment area,
a casing or cover to enclose the stand and the laser,
means for raising the casing with respect to the base bringing it to a raised position where access to the treatment area is allowed,
means for rotating the casing about a—in use—horizontal axis while the casing is in the raised position.

By rotation, the casing is tilted and its volume gets in the way less along the vertical. Thus the overall size of the apparatus can be reduced when the working area is uncovered by the casing.

According to a preferred simple but robust construction, the apparatus comprises:
two columns in the middle of which the laser is mounted,
two skids slidingly mounted on the columns to slide longitudinally on the columns,
wherein the casing is rotatably mounted on the skids.

To improve safety, the apparatus comprises unlocking and selective rotational locking means provided between the casing and a skid to allow rotation of the casing relative to the skid only when the casing is in its upper end-of-travel position.

In a preferred embodiment, advantageous because it takes advantage of the pre-existing columns, said engagement means of selective rotational locking and unlocking comprise
a linear guide on the column,
an element integral with the casing and protruding therefrom for sliding guided by the linear guide,
wherein the linear guide at said upper end-of-travel position comprises a portion configured to disengage said element.

More preferably, to simplify the structure, the linear guide on the column is a groove in the column and said element integral with the casing is a pin protruding from the casing.

To reduce the manual effort, there is a counterweight to balance the weight of the casing during the travel to the raised position. In particular, to better stabilize the moving parts, the counterweight is connected to a skid that supports the casing via a ring-shaped belt diverted by two pulleys.

The apparatus preferably comprises a means for exerting a force on the casing to balance its weight as it rotates about said axis, to facilitate the movement of the casing and avoid unwanted impacts.

In a variant, the means for exerting a force on the casing is an elastic means.

In another variant, the means for exerting a force on the casing is a gas spring, which, for example, is connected to the casing and one skid.

### BRIEF DESCRIPTION OF THE DRAWINGS

Further aspects and advantages of the present invention will better appear from the following detailed description of a preferred embodiment illustrated by way of example and not limitation with reference to the attached drawings, in which:

FIGS. 1 to 3 are side views of an apparatus according to the present invention in different operating configurations;

FIG. 4 is a three-dimensional view of a component of the apparatus,

FIG. 5 is a three-dimensional view of the apparatus;

FIGS. 6-7 are three-dimensional views of the apparatus without the component in FIG. 4.

### DETAILED DESCRIPTION

In the drawings, same or similar parts or components have been marked with the same reference numbers.

With reference to the Figures, an apparatus 10 for processing objects, particularly a laser welding or marking apparatus, is illustrated that comprises a base 12 with a treatment zone 18 where the object to be processed is placed to rest. The zone 18 is struck by the beam of a known laser 16 mounted translatably above the base 12 to bring it closer to or away from the underlying treatment zone 18.

A movable front casing 14 can rest on the base 12 and also translate relatively thereto. The laser 16 is housed under the casing 14 and becomes accessible when the casing 14 is lifted.

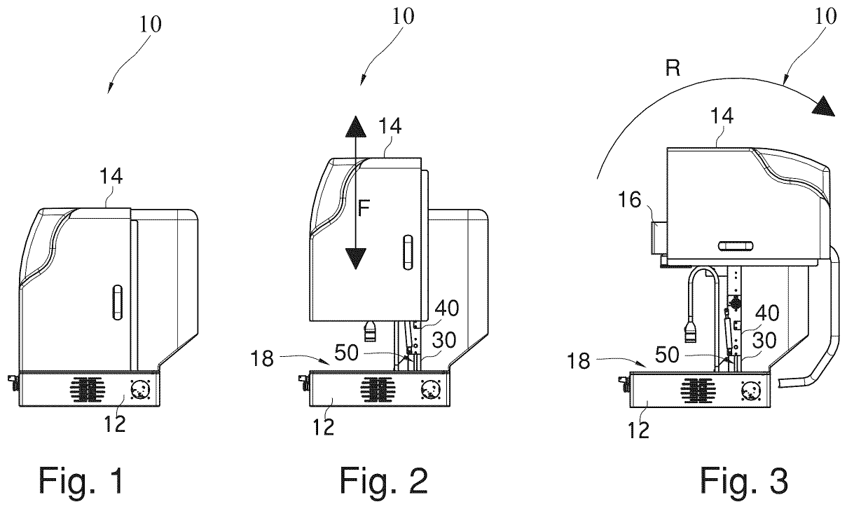

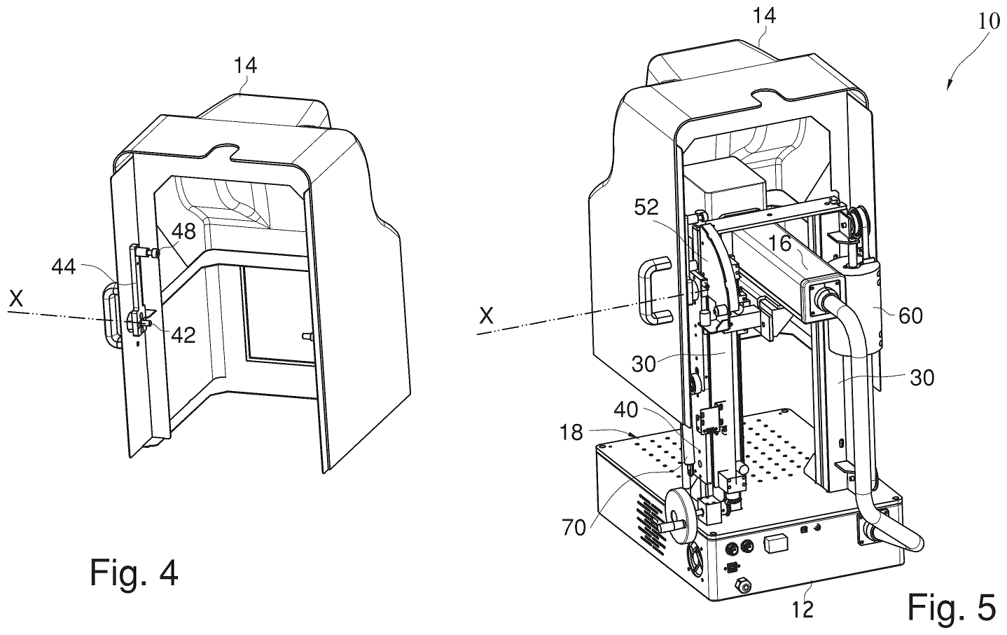

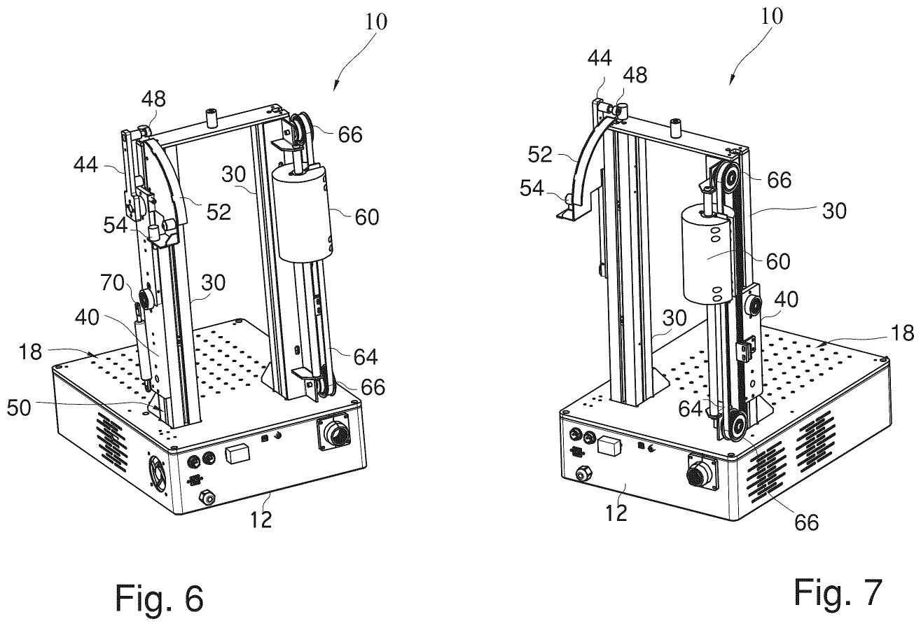

As can be seen from FIGS. 1-3, a peculiarity of the apparatus 10 is the way in which the casing 14 is displaceable relative to the base 12. the apparatus 10 comprises (see arrow F) means for linearly translating the casing 14, orthogonally to the plane of the base 12, from a first position in which it is resting on the base 12 (FIG. 1) to a second position in which it is raised relative to the base 12 (FIG. 2). The second position serves to be able to quickly insert workpieces under the laser 16 through the resulting gap (e.g. of 15 cm) between the base 12 and the lower edge of the casing 14. The apparatus 10 also comprises means for rotating the casing 14, when it is in the second position, about a—in use—horizontal X-axis-(FIGS. 3 and 5, see arrow R).

In this way, the apparatus 10 takes on greater practicality of use: the tilted casing 14 as in FIG. 3 does not take up much space and does not get in the way of the operator or of the equipment above the work surface, such as fume hoods, lighting apparatuses, and tool-holding arms. In addition, the rotation of the casing 14 allows convenient access to the laser 18, such as for maintenance or to replace the focal lens.

Preferably the rotation of the casing 14 is 90 degrees but different rotations also give the advantages listed above.

A simple construction of the above means is described below.

From the base 12 rise two parallel and spaced apart columns 30. The laser 16 is mounted between the top of the columns 30, in the center thereof.

The apparatus 10 takes advantage of the columns 30 to move the casing 14, with less production cost.
the columns 30 are two linear guides on each of which there is slidingly mounted a skid 40 to which the casing 14 is integral. E.g. the skid 40 is a recirculating ball skid or a sliding skid. E.g. the columns 30 are aluminum extruded elements, for simplicity of construction.

Inside the casing 14 there is a hub 42, pivoted pivotally on the skid 40 about the horizontal axis X, and an arm 44 equipped at its end with a pin 48 protruding toward the inside of the casing 14.

The pin 48 is inserted into a linear groove 50 provided in one of the columns 30 and can slide in that linear groove 50 while remaining in it during the translation stroke of the casing 14. Only at the upper end-stop of the casing 14 does the pin 48 pass the end of the column 30 and exit the linear groove 50. While during the upward translation travel of the casing 14 the cooperation between the pin 48 and the linear groove 50 keeps the arm 44 straight and parallel to the column 30, at the upper end-stop of the casing 14 the constraint imposed by the linear groove 50 on the pin 48 vanishes. Thus, when the casing 14 is in the raised position and at the end-stop (FIG. 2), the pin 48 no longer offers resistance and the casing 14 can rotate about the hub 42 and the X axis (FIG. 3).

A quarter of disk 52, having a radius approximately equal to the distance between the hub 42 and the pin 48, is mounted beside a column 30, so that the pin 48, when it rotates, can slide on the perimeter of quarter of disk 52. An angular end-of-travel stop 54 for the pin 48 is mounted on the quarter of disc 52, so that the casing 14 rotates a maximum of 90 degrees.

On the other column 30 is mounted an (optional) counterweight 60 sliding on a rod 62 attached to the column 30. The counterweight 60 is attached to a belt 64 ring-wound on two return pulleys 66. The belt 64 is connected to the skid 40 running on the column 30 and moves the counterweight 60 synchronously with the skid 40. Therefore the counterweight 60 is able to balance the weight of the casing 14 during the vertical translation and/or at any intermediate position between the base and the maximum height excursion.

A (optional) means for adjusting/locking the position of the casing 14 along its linear stroke is mounted on a column 30. Preferably the means for adjusting/locking is the same counterweight 60, but not necessarily.

An (optional) spring element or damper 70 is mounted between the casing 14 and a skid 40 to balance the weight of the casing 14 as it rotates. the element 70 may be, for example, a gas spring, a torsion spring, or a leaf spring.

Note that the displacement of the casing 14 is all manual although easy to implement, therefore the apparatus 10 is not complicated by expensive actuators.

Even a rotation of the casing 14 other than 90 degrees, e.g. lower, helps to improve the apparatus 10.

Other mechanical variants are possible to achieve the same effect on the casing 14, e.g. the use of guides and profiles with straight and semi-circular segments.

1. Apparatus for processing an object by laser, comprising:
a support base comprising a treatment area for the object,
a laser,
a stand mounted on the base to keep the laser at a distance from the base and pointed at the treatment area,
a casing or cover to enclose the stand and the laser,
means for lifting the casing or cover from the base to a raised position where access to the treatment area is permitted,
means for rotateing the casing or cover around a—in use—horizontal axis while the casing or cover is in the raised position.

2. Apparatus according to claim 1, comprising:
two columns in the middle of which the laser is mounted,
two skids slidingly mounted on the columns to slide longitudinally on the columns,
wherein the casing or cover is rotatably mounted on the skids.

3. Apparatus according to claim 2, comprising selective rotational locking and unlocking means between the casing or cover and a skid to allow rotation of the casing or cover relative to the skid only when the casing or cover is in its upper limit-stop.

4. Apparatus according to claim 3, wherein the rotational locking and unlocking means comprise
a linear guide on the column,
an element integral with the casing or cover and protruding from it to slide guided by the linear guide,
wherein the linear guide in correspondence with said upper limit stop comprises a portion configured to disengage said element.

5. Apparatus according to claim 4, wherein the linear guide on the column is a groove in the column and said element integral with the casing or cover is a pin protruding from the casing or cover.

6. Apparatus according to claim 1, comprising a counterweight for balancing the weight of the casing or cover as it travels toward the raised position.

7. Apparatus according to claim 6, wherein the counterweight is connected to a skid supporting the casing or cover by a ring belt returned by two pulleys.

8. Apparatus according to claim 1, comprising a means for exerting a force on the casing or cover to balance its weight during rotation about said axis.

9. Apparatus according to claim 8, wherein the means for exerting a force on the casing or cover is an elastic means.

10. Apparatus according to claim 8, wherein the means for exerting a force on the casing or cover is a gas spring.

11. Apparatus according to claim 9, wherein the means for exerting a force on the casing or cover is a gas spring.

12. Apparatus according to claim 2, comprising a counterweight for balancing the weight of the casing or cover as it travels toward the raised position.

13. Apparatus according to claim 12, wherein the counterweight is connected to a skid supporting the casing or cover by a ring belt returned by two pulleys.

14. Apparatus according to claim 2, comprising a means for exerting a force on the casing or cover to balance its weight during rotation about said axis.

15. Apparatus according to claim 14, wherein the means for exerting a force on the casing or cover is an elastic means.

16. Apparatus according to claim 3, comprising a counterweight for balancing the weight of the casing or cover as it travels toward the raised position.

17. Apparatus according to claim 16, wherein the counterweight is connected to a skid supporting the casing or cover by a ring belt returned by two pulleys.

18. Apparatus according to claim 17, comprising a means for exerting a force on the casing or cover to balance its weight during rotation about said axis.

19. Apparatus according to claim 18, wherein the means for exerting a force on the casing or cover is an elastic means.
